(19) United States
(12) Patent Application Publication
(10) Pub. No.: US 2026/0034731 A1
(43) Pub. Date: Feb. 5, 2026

(54) ADDITIVE MANUFACTURING USING RECYCLED MATERIALS

(71) Applicant: PPG Industries Ohio, Inc., Cleveland, OH (US)

(72) Inventors: Bret Michael Boyle, Pittsburgh, PA (US); Jacob Michael Kupas, Pittsburgh, PA (US); Cynthia Kutchko, Pittsburgh, PA (US)

(73) Assignee: PPG Industries Ohio, Inc., Cleveland, OH (US)

(21) Appl. No.: 19/101,317

(22) PCT Filed: Jun. 6, 2023
(86) PCT No.: PCT/US2023/067951

§ 371 Date: Feb. 5, 2025

Related U.S. Application Data
(60) Provisional application No. 63/371,395, filed on Aug. 14, 2022.

(51) Int. Cl. B29C 64/314; B29C 64/336; B29K 75/00; B29K 475/00; B29K 477/00; B33Y 10/00; B33Y 40/00; B33Y 70/00

(52) U.S. Cl. CPC B29C 64/314; B29C 64/336; B33Y 10/00; B33Y 40/00; B33Y 70/00; B29K 2075/02; B29K 2475/02; B29K 2477/10

(57) ABSTRACT

Compositions for reactive additive manufacturing using recycled components obtained from previously manufactured articles produced by additive manufacturing, as well as methods of making and using the compositions. The compositions may include a first reactive component and a second reactive component, the first and second reactive components reactive with each other, together with particles comprising a recycled, cured thermoset component, the particles present in an amount greater than 2 wt. % based on total weight of the composition, and a filler present in an amount from 1 to 10 wt. % based on a total weight of the composition.

### CROSS-REFERENCE TO RELATED APPLICATIONS

This application claims the benefit under 35 U.S.C. § 119(e) of U.S. Provisional Application No. 63/371,395 filed on Aug. 14, 2022 which is incorporated by reference in its entirety.

### GOVERNMENT LICENSE RIGHTS

This invention was made with government support under Government Contract No. W911NF-17-2-0227 Additive Manufacturing (U.S. Army Research Laboratory, ARL). The government may have certain rights in the invention.

### FIELD

The present disclosure relates to a thermoset composition for additive manufacturing including recycled materials obtained from previously manufactured articles produced by additive manufacturing.

### BACKGROUND

3D printing is a process that is used to create objects out of cured compositions, such as plastics. The cured composition can be made of a thermoset composition. During the printing of the object using a thermoset composition, at least two co-reactive compounds are mixed together to create a co-reactive composition. The thermoset composition may be used in ambient reaction extrusion (ARE) printing, in which the co-reactive composition is deposited onto a printing platform and cured at ambient conditions.

Unwanted parts and excess material left over from the extrusion process may be created during ARE printing and in other types of additive manufacturing, and printed articles may have a limited useful life. This extra material and used articles are commonly disposed of, and more effective uses of such materials are desired.

### SUMMARY

The present disclosure provides compositions for reactive additive manufacturing using recycled components obtained from previously manufactured articles produced by additive manufacturing, as well as methods of making and using the compositions. The compositions may include a first reactive component and a second reactive component, the first and second reactive components reactive with each other, together with particles comprising a recycled, cured thermoset component, the particles present in an amount greater than 2 wt. % based on total weight of the composition, and a filler present in an amount from 1 to 10 wt. % based on a total weight of the composition.

The present disclosure also provides a method of forming an object with a reactive additive manufacturing composition, including combining a first reactive component, a second reactive component, and particles comprising a reaction product of a cured thermoset component, the reaction product particles present in an amount of at least 2 wt. % based on a total weight of the composition; mixing the first reactive component, second reactive component, and the reaction product particles; and sequentially depositing the composition in a plurality of layers to form a three-dimensional object.

The present disclosure also provides for a composition for reactive additive manufacturing, including a first reactive component; a second reactive component, the first and second reactive components reactive with each other; particles comprising a cured thermoset component, wherein the reaction product particles further comprise a pigment present in a total amount from 0.0002 to 0.05 wt. % based on the original pigment added in the composition of the reaction product particles divided by the total weight of the reaction product particles added to the formulation; and a filler present in an amount of from 1 to 10 wt. % based on a total weight of the composition.

### DESCRIPTION OF THE DRAWINGS

FIG. 1 is a flowchart illustrating a method of making a 3D printed product using additive manufacturing.

FIG. 2 is a flowchart illustrating a method of making a 3D printed product using additive manufacturing and recycled, cured thermoset particles as filler.

FIG. 3 is a plot of the vertical height of each stack of deposited composition containing recycled, cured thermoset particles as filler as a function of stack layer.

FIG. 4 is a plot of the vertical height of each stack of deposited composition containing standard composition of co-reactive composition and non-recycled filler as a function of stack layer.

FIG. 5 shows a four-layer stack of the deposited composition containing recycled, cured thermoset particles as filler.

FIG. 6 is a cross-sectional microscopy image of a polyurea part with polyurea recycled, cured thermoset particles incorporated as illustrated in Example 3.

### DETAILED DESCRIPTION

The present disclosure provides a reactive additive manufacturing compositions and articles for use in 3D printing, as well as methods of making and using such compositions. The compositions may also comprise an amount of recycled previously printed 3D material.

In the process of 3D printing, excess or otherwise unwanted articles may be produced. These unwanted articles may be ground down into previously printed 3D material particles. The particles may then be used as filler in reactive additive manufacturing compositions. Advantageously, the previously printed 3D material filler may enhance certain properties of the composition, including buildability, and may also contribute to the pigmentation of the composition.

### I. Definitions

For purposes of the following detailed description, it is to be understood that the disclosure may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” For example, numerical ranges provided for weight percentages of components or amounts of components added should be construed as being modified by the term “about.” Accordingly, unless indicated to the contrary, the numerical parameters set forth in the following specification and attached claims are approximations that may vary depending upon the desired properties to be obtained by the present disclosure. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “i to 10” is intended to include all sub-ranges from (and including) the recited minimum value of 1 to the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

“Polymer” and “Polymeric” refers to oligomers, homopolymers (e.g., prepared form a single monomer species), copolymers (e.g., prepared form at least two monomer species), terpolymers (e.g., prepared from at least three monomer species), and graft polymers.

“Printing” refers to any process in which a material is deposited onto and/or reacted with another material and/or itself, for example three-dimensional printing.

“Co-reactive composition” refers to a composition comprising at least two different compounds capable of chemically reacting with each other to form covalent bonds.

“Reactive functional group” refers to a chemical group capable of chemically reacting with another reactive functional group to form a covalent bond.

“Reactive compound” refers to a compound comprising at least one reactive functional group.

“Extrusion” refers to a process used to create objects in which material is pushed through a die. An extrusion die has a shape and dimensions suitable to build an object. An extrusion die may have a fixed shape or a shape that can be changed during extrusion.

“Filler” refers to any compound added to a reactive compound or co-reactive composition that is nonreactive with at least a part of the compound and/or composition. Fillers as used herein encompasses particulates, fibers, slurries, mixtures, and any other compound and combinations thereof that may be added to a reactive compound and/or co-reactive composition.

“ARE filler” refers to ground previously printed 3D material made via ambient reactive extrusion used as filler in a co-reactive composition.

“Ambient conditions/temperature” refers to room temperature or about 20° C. to 28° C.

“Recycled components/particles” refers to previously printed materials obtained from manufactured articles/objects that comprise a cured thermoset component.

### II. Ambient Cured Co-Reactive Polymer Compositions

The present disclosure provides co-reactive compositions. The system may comprise at least two co-reactive components, which may include polymers, prepolymers and/or oligomers. The co-reactive components are reactive with one another, such that the system may be cured at ambient temperature and pressure.

A variety of chemistries may be employed in additive manufacturing of co-reactive components. A co-reactive composition refers to a composition having at least one first component that is reactive with a least one second component. In addition to the first component and the second component, the composition may include other reactive and/or non-reactive components and additives such as fillers, rheology modifiers, adhesion promoters, pigments, and others. The composition may include one or more solid state pigments. The at least one first component may comprise a first functional group and the at least one second component, different from the first component, may comprise a second functional group, where the first functional group is reactive with the second functional group. The reaction may proceed without a catalyst.

The first component and the second component each independently may have a single reactive functional group, but generally comprise two or more reactive functional groups such as from 2 to 20 functional groups, from 2 to 16, from 2 to 12, from 2 to 8, from 2 to 6, from 2 to 4, or from 2 to 3 reactive functional groups per molecule. The reactive functional groups may be terminal functional groups, pendant functional groups, or a combination of terminal and pendant functional groups.

The first co-reactive component may include compounds having more than one type of functional group A (see Table 1, below), and the second co-reactive component may include compounds having more than one type of functional group B (see Table I, below), such that an additive manufacturing material can comprise at least two sets of co-reactive A and B groups, wherein at least one co-reactive component has a functional group that is saturated. A first co-reactive component may have compounds with hydroxyl groups and secondary amine groups (i.e., at least two different functional groups) and the second co-reactive component may have compounds with isocyanate groups. One or both of the co-reactive components may optionally comprise a catalyst for catalyzing the reaction between the A groups and the B groups.

TABLE 1
Exemplary co-reactive chemistries

| Functional Group A | Functional Group B |
|---|---|
| Carboxylic Acid | Epoxide |
| Activated unsaturated groups such as | Primary or Secondary Amine |
| acrylate, maleic, or fumaric | |
| Isocyanate | Primary or Secondary Amine |
| Isocyanate | Hydroxyl |
| Cyclic Carbonate | Primary or Secondary Amine |
| Acetoacetate | Primary or Secondary Amine |
| Epoxide | Primary or Secondary Amine |
| Thiol | Alkenyl |
| Thiol | Vinyl Ether |
| Thiol | Methacrylate |
| Activated unsaturated groups such as | Malonatc |
| acrylate or maleic | |

The first component and the second component can be combined in a suitable ratio to form a curable co-reactive composition. The functional Group A to functional Group B equivalent ratio of a curable composition can be as about 1.0:1.0 or greater, about 1.0:1.2 or greater, about 1.0:1.4 or greater, about 1.0:1.6 or lower, about 1.0:1.8 or lower, about 1.0:2.0 or lower, or about 1.0:1.0 or greater, about 1.2:1.0 or greater, about 1.4:1.0 or greater, about 1.6:1.0 or lower, about 1.8:1.0 or lower, about 2.0:1.0 or lower, or within any range using these endpoints.

Examples of co-reactive compositions may include polyisocyanates and polyamines which react to form polyurcas. The reaction of polyisocyanates and polyamines may proceed rapidly at ambient conditions thereby avoiding the need to control heat flow during deposition. The polyurea reaction may also proceed rapidly in the absence of a catalyst.

### A. Polyurea Compositions

The polyisocyanate component may comprise a polyisocyanate prepolymer and/or polyisocyanate monomer and the polyamine component may comprise a polyamine prepolymer and/or polyamine monomer. The polyisocyanate prepolymer and/or polyamine prepolymer can have a number average molecular weight as low as about 500 Daltons, about 1000 Daltons, about 2000 Daltons, about 5000 Daltons, about 7000 Daltons, about 10,000 Daltons, as high as about 11,000 Daltons, about 13,000 Daltons, about 15,000 Daltons, about 20,000 Daltons, or within any range including these endpoints, such as 500 Daltons to 20,000 Daltons, 1000 Daltons to 15,000 Daltons, 2000 Daltons to 13,000 Daltons, 5000 Daltons to 11,000 Daltons, or 7000 Daltons to 10,000 Daltons. Number average molecular weight may be determined by size exclusion chromatography using polystyrene standards.

The isocyanate functional component that may include polyisocyanate monomers and/or prepolymers, or a blend of polyisocyanates. For example, a polyisocyanate prepolymer can be prepared by reacting a polyol prepolymer and/or a polyamine prepolymer with a polyisocyanate such as a diisocyanate. Suitable polyisocyanate prepolymers are commercially available.

Suitable monomeric polyisocyanates may include isophorone diisocyanate (lPDI), which is 3,3,5-trimethyl-5-isocyanato-methyl-cyclohexyl isocyanate; hydrogenated diisocyanates such as cyclohexylene diisocyanate, 4,4′-methylenedicyclohexyl diisocyanate (H₁₂MDI); mixed aralkyl diisocyanates, such as tetramethylxylyl diisocyanates, OCN—C(—CH₃)₂—C₆H₄C(CH₃)₂—NCO; and polymethylene isocyanates such as 1,4-tetramethylene diisocyanate, 1,5-pentamethylene diisocyanate, 1,6-hexamethylene diisocyanate (HMDI), 1,7-heptamethylene diisocyanate, 2,2,4- and 2,4,4-trimethylhexamethylene diisocyanate, 1,10-decamethylene diisocyanate, and 2-methyl-1,5-pentamethylene diisocyanate.

Suitable monomeric aromatic polyisocyanates may include phenylene diisocyanate, toluene diisocyanate (TDI), xylene diisocyanate, 1,5-naphthalene diisocyanate, chlorophenylene 2,4-diisocyanate, bitoluene diisocyanate, dianisidine diisocyanate, toluidine diisocyanate and alkylated benzene diisocyanates generally; methylene-interrupted aromatic diisocyanates such as methylenediphenyl diisocyanate, especially the 4,4′-isomer (MDI), including alkylated analogs such as 3,3′-dimethyl-4,4′-diphenylmethane diisocyanate and polymeric methylenediphenyl diisocyanate.

Suitable polyisocyanates also include polyisocyanates prepared from dimers and trimers of diisocyanate monomers. Dimers and trimers of diisocyanate monomers can be prepared, for example, by methods described in U.S. Pat. No. 5,777,061 at column 3, line 44 through column 4, line 40, which is incorporated by reference in its entirety. Dimers and trimers of diisocyanate monomers may contain linkages selected from isocyanurate, uretdione, biuret, allophanate and combinations thereof: such as Desmodur® N3600, Desmodur® CP2410, and Desmodur@N3400, available from Bayer Material Science.

A polyisocyanate may also comprise a polyisocyanate prepolymer. For example, a polyisocyanate may include an isocyanate-terminated polyether diol, an isocyanate-terminated extended polyether diol, or a combination thereof. An extended polyether diol refers to a polyether diol that has been reacted with an excess of a diisocyanate resulting in an isocyanate-terminated polyether prepolymer with increased molecular weight and urethane linkages in the backbone. Examples of polyether diols include Terathane® polyether diols such as Terathane® 200 and Terathane® 650 available from Invista, or the PolyTHF® polyether diols available from BASF. Isocyanate-terminated polyether prepolymers can be prepared by reacting a diisocyanate and a polyether diol as described in U.S. Application Publication No. 2013/0244340, which is incorporated by reference in its entirety.

A polyisocyanate prepolymer may include an isocyanate-terminated polytetramethylene ether glycol such as polytetramethylene ether glycols produced through the polymerization of tetrahydrofuran. Examples of suitable polytetramethylene ether glycols include Polymeg® polyols (LyondellBasell), PolyTHF® polyether diols (BASF), or Terathane® polyols (Invista).

Polyisocyanate prepolymers may also include isocyanate-terminated polyetheramines. Examples of polyether amines include polyetheramines, such as Jeffamine® (Huntsman Corp.), and polyetheramines available from BASF. Examples of suitable polyetheramines may include polyoxypropylenediamine.

The amine-functional co-reactive component may include primary, secondary, or tertiary amines, or combinations thereof. Examples of suitable aliphatic amines include ethylamine, the isomeric propylamines, butylamines, pentylamines, hexylamines, cyclohexylamine, ethylene diamine, 1,3-bis(aminomethyl)diamine, 1,2-diaminopropane, 1,4-diaminobutane, 1,3-diaminopentane, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof.

Example of suitable secondary amines may include aliphatic amines, such as a cycloaliphatic diamine. Such amines are available commercially from Huntsman Corporation (Houston, TX) under the designation of Jetfflink® such as Jefflink® 754. Other examples include Clearlink® 1000 (Dorf-Ketal Chemicals, LLC), and aspartic ester functional amines, such as those available under the name Desmophen® such as NH1220, Desmophen® NH 1420, and Desmophen® NH 1520 (Bayer Materials Science LLC). A secondary amine can be the reaction product of isophorone diamine and acrylonitrile, such as Polyclear® 136 (available from BASF/Hansen Group LLC). A polyamine can also be provided as an amine-functional resin. For example, an amine-functional resin may comprise an ester of an organic acid, such as an aspartic ester-based amine-functional reactive resin that is compatible with isocyanates; e.g., one that is solvent-free, and/or has a mole ratio of amine-functionality to the ester of no more than 1:1 so there remains no excess primary amine upon reaction. An example of such polyaspartic esters is the derivative of diethyl maleate and 1,5-diamino-2-methylpentane, available commercially from Bayer Corporation under the trade name Desmophen® NH1220. Other suitable compounds containing aspartate groups may be employed as well. Additionally, the secondary polyamines can include polyaspartic esters which can include derivatives of compounds such as maleic acid, fumaric acid esters, aliphatic polyamines and the like.

Suitable secondary amines may include acrylates and methacrylate-modified amines, including both mono- and poly-acrylate modified amines as well as acrylate or methacrylate modified mono- or poly-amines. Acrylate or methacrylate modified amines may include aliphatic amines. Secondary amines may further aliphatic amines, such as a cycloaliphatic diamine. The amine may be provided as an amine-functional resin. Such amine-functional resins may be a relatively low viscosity, amine-functional resin suitable for use in the composition of high solids polyurea three-dimensional objects. An amine-functional resin may comprise an ester of an organic acid, for example, an aspartic ester-based amine-functional reactive resin that is compatible with isocyanates; e.g., one that is solvent-free. An example of such polyaspartic esters is the derivative of diethyl maleate and 1,5-diamino-2-methylpentane, available commercially from Bayer Corporation, PA under the trade name Desmophen™ NH1220. Other suitable compounds containing aspartate groups may be employed as well.

The polyamine may include polyoxyalkyleneamines. Polyoxyalkyleneamines contain two or more primary amino groups attached to a backbone derived, for example, from propylene oxide, ethylene oxide, or a mixture thereof. Examples of such amines include polyoxypropylenediamine and glycerol tris[poly(propylene glycol), amine-terminated]ether such as those available under the designation Jeffamine™ from Huntsman Corporation.

The amine-functional co-reactive component may also include an aliphatic secondary amine such as Clearlink® 1000, available from Dor-Ketal Chemicals, LLC. The amine-functional co-reactive component may comprise an amine-functional aspartic acid ester, a polyoxyalkylene primary amine, an aliphatic secondary amine, or a combination of any of the foregoing.

In addition to the polyisocyanates and polyamines described above, polythiols may comprise at least one of the co-reactive components. The polythiol may comprise a monomeric polythiol, a polythiol prepolymer, or a combination thereof. A polythiol may comprise a dialkenyl having a thiol functionality, or a polyalkenyl having a thiol functionality.

A polythiol may comprise any suitable thiol-terminated prepolymers or combination of thiol-terminated prepolymers. Examples of suitable thiol-terminated sulfur-containing prepolymers include thiol-terminated polythioethers, thiol-terminated polysulfides, thiol-terminated sulfur-containing polyformals, and thiol-terminated monosulfides.

### B. Michael Addition Compositions

Certain co-reactive compositions provided by the present disclosure may employ Michael addition reactive components. Co-reactive compositions employing a Michael addition curing chemistry may comprise a Michael donor compound and a Michael acceptor compound. In instances where Michael addition comprises 1,4 addition of nitrogen nucleophiles, the addition may be referred to as an Aza-Michael rection or addition.

The Michael donor compound may comprise a Michael donor monomer, a Michael donor prepolymer, or a combination thereof. Michael donors may include amines, hydroxy group containing oligomers or polymers, acetoacetates, malonates, thiols, and combinations of any of the foregoing.

The Michael acceptor compound can comprise a Michael acceptor monomer, a Michael acceptor prepolymer, or a combination thereof. A Michael acceptor group refers to an activated alkenyl group such as an alkenyl group proximate to an electron-withdrawing group such as a ketone, nitro, halo, nitrile, carbonyl, or nitro group. Examples of Michael acceptor groups include vinyl ketone, vinyl sulfone, quinone, enamine, ketimine, aldimine, oxazolidine, acrylate, acrylate esters, acrylonitrile, acrylamide, maleimide, alkylmethacrylates, vinyl phosphonates, and vinyl pyridines.

Suitable examples of catalysts for Michael addition chemistries include tributylphosphine, triisobutylphosphine, tri-tertiary-butylphosphine, trioctyl phosphine, tris(2,4,4-trimethylpentyl)phosphine, tricyclopentylphosphine, tricyclohexalphosphine, tri-n-octylphosphine, tri-n-dodecylphosphine, triphenyl phosphine, and dimethyl phenyl phosphine.

Examples of suitable Michael donors, Michael acceptors, and catalysts are shown below in Table 2.

TABLE 2
Examples of Michael donors, Michael acceptors, and catalysts

| Michael donors | Michael acceptors | Catalysts |
|---|---|---|
| Acetylacetonates | Methacrylates | Strong bases such as DBU, |
| | | DBN, TMG, TMP, TBD |
| | | (MFC) |
| Malonates | Cyanoacrylates | Nucleophilic catalysts |
| | | such as |
| | | dimethylphenylphosphine |
| Nitroalkancs | Vinyl others | Tctrabutylammonium |
| | | fluoride |
| Any other active | Vinylpyridine | |
| methylene | | |
| | Any α,β-unsaturated | |
| | carbonyl | |

The co-reactive components may react with one another at moderate temperatures, such as about 140° C. or less, about 100° C. or less, about 60° C. or less, about 50° C. or less, about 40° C. or less, about 30° C. or less, or about 25° C. or less. The co-reactive components may react with one another at ambient temperatures, such as 20° C. to 28° C.

### C. Polythiol Compositions

A polythiol coreactive component refers to polyfunctional compounds containing two or more thiol-functional groups (—SH). Suitable polythiol-functional compounds include polythiols having at least two thiol groups including monomers and prepolymers. A polythiol may have ether linkages (—O—), thioether linkages (—S—), including polysulfide linkages (—Sₓ—), where x is at least 2, such as from 2 to 4, and combinations of such linkages.

Examples of suitable polythiols include compounds of the formula R¹—(SH)n, where R¹ is a polyvalent organic moiety and n is an integer of at least 2, such as from 2 to 6.

Examples of suitable polythiols include esters of thiol-containing acids formed by reacting a thiol-containing acid of formula HS—R²—COOH where R² is an organic moiety with a polyhydroxy compound of the structure R³—(OH)ₙ where R³ is an organic moiety and n is at least 2, such as from 2 to 6. These components may be reacted under suitable conditions to give polythiols having the general structure: R³—(OC(O)—R²—SH), wherein R², R³ and n are as defined above.

Examples of thiol-containing acids include thioglycolic acid (HS—CH2COOH), α-mercaptopropionic acid (HS—CH(CH3)-COOH) and β-mercaptopropionic acid (HS—CH2CH2COOH) with polyhydroxy compounds such as glycols, triols, tetraols, pentaols, hexaols, and mixtures thereof. Other suitable polythiols include ethylene glycol bis(thioglycolate), ethylene glycol β(-mercaptopropionate), trimethylolpropane tris (thioglycolate), trimethylolpropane tris (β-mercaptopropionate), pentaerythritol tetrakis (thioglycolate) and pentaerythritol tetrakis (β-mercaptopropionate), and mixtures thereof.

### D. Thiol-ene Compositions

A reactive component composition ii) provided by the present disclosure can be based on thiol-ene chemistry. For example, a reactive component ii) having thiol-ene functionality may include a polyenecoreactive component comprising compounds or prepolymers having terminal and/or pendent olefinic double bonds, such as terminal alkenyl groups. Examples of such compounds include (meth)acrylic-functional (meth)acrylic copolymers, epoxy acrylates such as epoxy resin (meth)acrylates (such as the reaction product of bisphenol A diglycidyl etherand acrylic acid), polyester (meth)acrylates, polyether (meth)acrylates, polyurethane (meth)acrylates, amino (meth)acrylates, silicone (meth)acrylates, and melamine (meth)acrylates.

Examples of suitable polyurethane (meth)acrylates include reaction products of polyisocyanates such as 1,6-hexamethylene diisocyanate and/or isophorone diisocyanate including isocyanurate and biuret derivatives thereof with hydroxyalkyl (meth)acrylates such as hydroxyethyl (meth)acrylate and/or hydroxypropyl (meth)acrylate. Examples of suitable polyester (meth)acrylates are the reaction products of (meth)acrylic acid or anhydride with polyols, such as diols, triols and tetraols, including alkylated polyols, such as propoxylated diols and triols. Examples of suitable polyols include 1,4-butane diol, 1,6-hexane diol, neopentyl glycol, trimethylol propane, pentaerythritol and propoxylated 1,6-hexane diol.

Examples of suitable polyester (meth)acrylates include glycerol tri(meth)acrylate, trimethylolpropane tri(meth)acrylate, pentaerythritol tri(meth)acrylate, and pentaerythritol tetra(meth)acrylate. Mixtures of polyurethane (meth)acrylates, and polyester (meth)acrylates may be used.

In addition to (meth)acrylates, (meth)allyl compounds may be used either alone or in combination with (meth)acrylates. Examples of (meth)allyl compounds include polyallyl ethers such as the diallyl ether of 1,4-butane diol and the allyl ether of trimethylol propane. Examples of other (meth)allyl compounds include polyurethanes containing (meth)allyl groups. For example, reaction products of polyisocyanates such as 1,6-hexamethylene diisocyanate and/or isophorone diisocyanate including isocyanurate and biuret derivatives thereof with hydroxy-functional allyl ethers, such as the monoallyl ether of 1,4-butane diol and the diallylether of trimethylol propane can be used.

Isocyanate functionality may be incorporated into a coreactive component in a number of ways. The polyurethane (meth)acrylate or the polyurethane (meth)allyl compound may be prepared in a manner such that the reaction product contains unreacted isocyanate groups. For example, the above-mentioned reaction product of 1,6-hexamethylene diisocyanate and/or isophorone diisocyanate with hydroxyethyl (meth)acrylate and/or hydroxypropyl (meth)acrylate are reacted in an NCO/OH equivalent ratio of greater than 1. Alternately, such reaction products may be prepared such that they are isocyanate free, i.e., NCO/OH equivalent ratio equal to or less than 1, and a separate isocyanate compound such as a polyisocyanate maybe included in the coreactive component.

### III. Non-Recycled Fillers

The compositions of the present disclosure may further include various non-recycled fillers.

Any filler or combination of fillers can be used to control and/or facilitate a three-dimensional printing operation, including mixing and extrusion. For example, the filler(s) can control the viscosity, mixing, hydrophobicity, hydrophilicity, rheology, or a combination of any of the foregoing.

A filler may comprise, for example, an inorganic filler, an organic filler, a low-density filler, an electrically conductive filler, or a combination of any of the foregoing.

A filler may comprise, for example, an inorganic filler, an organic filler, a low-density filler, an electrically conductive filler, or a combination of any of the foregoing. A filler may also comprise ground construction materials.

Inorganic fillers useful in compositions provided by the present disclosure may include carbon black, calcium carbonate, precipitated calcium carbonate, calcium hydroxide, hydrated alumina (aluminum hydroxide), fumed silica, silica, precipitated silica, silica gel, and combinations of any of the foregoing.

Organic fillers useful in compositions provided by the present disclosure may include thermoplastics, thermosets, or a combination thereof. Examples of suitable organic fillers include epoxies, epoxy-amides, ethylene tetrafluoroethylene copolymers, polyethylenes, polypropylenes, polyvinylidene chlorides, polyvinylfluorides, tetrafluoroethylene, polyamides, polyimides, ethylene propylenes, perfluorohydrocarbons, fluoroethylenes, polycarbonates, polyetheretherketones, polyetherketones, polyphenylene oxides, polyphenylene sulfides, polyether sulfones, thermoplastic copolyesters, polystyrenes, polyvinyl chlorides, melamines, polyesters, phenolics, epichlorohydrins, fluorinated hydrocarbons, polycyclics, polybutadienes, polychloroprenes, polyisoprenes, polysulfides, polyurethanes, isobutylene isoprenes, silicones, styrene butadienes, liquid crystal polymers, and combinations of any of the foregoing.

Further examples of suitable organic fillers include polyamides, such as polyamide 6 and polyamide 12, polyimides, polyethylene, polyphenylene sulfides, polyether sulfones, polysulfones, polyethylimides, polyvinyl fluorides, thermoplastic copolyesters, and combinations of any of the foregoing.

A co-reactive composition provided by the present disclosure can comprise a weight percentage of non-recycled filler, for example, from 1 wt. %, 2 wt. %, 3 wt. %, 4 wt. %, 5 wt. %, or 6 wt. %, 7 wt. %, 8 wt. %, 9 wt. %, or 10 wt. %, or within any range using any two of the foregoing as endpoints, such as 1 wt. % to 10 wt. %, 2 wt. % to 9 wt. %, 3 wt. % to 8 wt. %, 4 wt. % to 7 wt. %, or 5 wt. % to 6 wt. %, where wt. % is based on the total weight of the co-reactive composition.

### IV. Additives and Pigments

The compositions of the present disclosure may further include various additives, such as rheology modifiers, flow control agents, plasticizers, thermal stabilizers, UV stabilizers, wetting agents, dispersing auxiliaries, deformers, reactive diluents, flame retardants, catalysts, pigments, solvents, adhesion promoters, antioxidants, and combinations of any of the foregoing.

The co-reactive composition provided by the present disclosure can comprise a pigment or a combination of colorants. A colorant can comprise, for example, a pigment, dye, tint, special effects colorant, or photosensitive compound.

Examples of suitable colorants include dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the compositions by grinding or simple mixing.

Examples of suitable pigments and/or pigment compositions include carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, carbon fiber, graphite, other conductive pigments and/or fillers and mixtures thereof.

Examples of suitable dyes include those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazine, azo, indigoid, nitro, nitroso, oxazine, phthalocyanine, quinoline, stilbene, and triphenyl methane.

Examples of suitable tints include pigments dispersed in water-based or water miscible carriers such as Aqua-Chem® 896 commercially available from Degussa, Inc., Charisma® Colorants and Maxitoner@Industrial Colorants commercially available from Accurate Dispersions division of Eastman Chemical, Inc.

A pigment can comprise, for example, a special effect colorant that produces one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity or texture. Special effect compositions can produce a color shift, such that the color of the coating changes when the coating is viewed at different angles. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

A pigment used in the composition of the present invention can comprise a photosensitive compound and/or photochromic compound, which reversibly alters its color when exposed to one or more light sources. Photochromic and/or photosensitive activated can be activated by exposure to radiation of a specified wavelength.

A co-reactive composition provided by the present disclosure can comprise a weight percentage of pigment from 0.1 wt. %, 0.15 wt. %, 0.2 wt. %, 0.3 wt. %, or 1 wt. % to 2 wt. %, 4 wt. %, 6 wt. %, 8 wt. %, or 10 wt. %, or within any range using any two of the foregoing as endpoints, such as 0.1 wt. % to 10 wt. %, 0.15 wt. % to 8 wt. %, 0.2 wt. % to 6 wt. %, 0.3 wt. % to 4 wt. %, or 1 wt. % to 2 wt. %, where wt. % is based on the total weight of the co-reactive composition.

### V. Printing

The co-reactive compositions as disclosed herein may be used for additive manufacturing or 3D printing. The co-reactive compositions may be used in ambient reaction extrusion (ARE) printing, in which reactive compounds are mixed to form a co-reactive composition, deposited onto a printing platform or onto a co-reactive composition, and cured at ambient conditions.

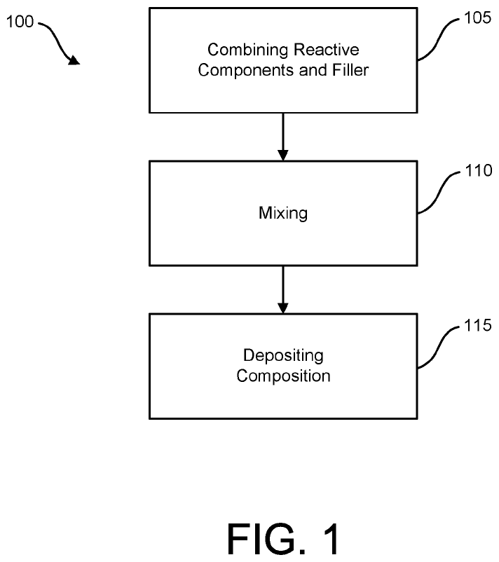

Referring to FIG. 1, a method 100 is shown for printing a 3D object. Method 100 comprises a combining step 105, a mixing step 110, and a depositing step 115. In combining step 105, a first reactive compound, a second reactive compound, and at least one filler are combined. The compounds and filler may be any of those described in the above sections. Prior to combination, the first reactive compound may be stored in a first reservoir, and the second reactive compound may be stored in a second reservoir. The filler may be stored with the first or second compounds in the first or second reservoirs respectively or may be stored in a third reservoir. Multiple fillers may be used, and either or both of the first and second compounds may be combined with a filler before combining step 105. Method 100 may comprise multiple combining steps, in which multiple components are combined, such as reactive components and fillers. The first reactive compound, second reactive compound, and at least one filler may all be combined in a fourth reservoir in combining step 105.

Mixing step 110 comprises mixing the first reactive compound, second reactive compound, and at least one filler to form a co-reactive composition. The mixing parameters such as time spent mixing, mixing speed, mixing device, temperature, and/or pressure may vary depending on operating parameters or desired product parameters such as the amount and type of compounds and fillers used, the volume of components in the mixture, desired properties of the co-reactive composition, desired properties of the printed object, and any combination of the foregoing. Mixing step 110 may be carried out in the same reservoir as the combining step 105. For example, the mixing step 110 may be carried out in a static mixer. Mixing step 110 may comprise mixing devices such as baffles, paddles, impellors, agitators, and any combination of the foregoing. The first reactive compound may begin to react with the second reactive compound at any point after the combining step 105, such as during and/or after mixing step 110.

Depositing step 115 comprises depositing the co-reactive composition formed from mixing step 110 onto a printing surface to form a printed object. The printing surface may be a printing bed or any other material. As the object is built up, the printing surface may be a surface of the co-reactive composition that has already been deposited. The co-reactive composition may be extruded through a die from the mixer or mixing reservoir onto the printing surface. As the co-reactive composition reacts and cures, the composition may begin to solidify into a solid, 3D object. The speed of the reaction/curing may be altered through selection of the reactive compounds and filler(s) used, as well as through the conditions at which mixing step 110 and/or depositing step 115 occur. The mixing step 110 and depositing step 115 may occur at ambient conditions. As the co-reactive composition is deposited onto other layers or surfaces of already deposited co-reactive composition, the newly deposited composition may react/cure with the already deposited composition in order to form covalent bonds between the deposited layers. The newly deposited composition may also be deposited onto a composition that is entirely or mostly cured.

The depositing step 115 may be carried out through a 3D printing device. The co-reactive composition may be extruded through a printing head coupled to a movable printing arm onto a printing bed. The printing bed itself may be movable relative to the printing head and/or arm. Movement of the printing head relative to the printing bed, either through movement of the head/arm, the bed, or combinations thereof, allows for the deposition of material into a three-dimensional shape.

Different co-reactive compositions, reactive compounds, and/or fillers may be added or combined with other co-reactive compositions, reactive compounds, and/or fillers at any point during method 100. A first co-reactive composition may be deposited onto a printing bed, and a second co-reactive composition may be deposited onto the first co-reactive composition. Additionally, a first co-reactive composition may be made through a mixing step, and another filler may be added after the co-reactive composition was formed.

The amount of a co-reactive component may be dynamically changed during printing such that different parts can be fabricated using different print speeds. Certain portions of an object may have detail that is best fabricated using slower print speeds, while other portions of the object may be fabricated at higher print speeds. During the three-dimensional printing operation, the amount of a co-reactive component may be changed such that the gel time of the co-reactive composition is slower at slower print speeds, and faster at faster print speeds.

### VI. Previously Printed, Recycled Cured Thermoset Particles

The present disclosure provides a composition and method of use to recycle printed 3D objects and/or scrap material from 3D printing operations. In other words, the present disclosure provides a composition and method for additive manufacturing including previously printed, or recycled, materials obtained from previously manufactured articles produced by additive manufacturing. Once a 3D printed object has served its use and is no longer needed, the object comprising a cured thermoset component can be ground down into particles to create a previously printed 3D material filler that, when added to a co-reactive composition as previously described, generally exhibits superior or comparable rheological characteristics and/or buildability when compared to standard co-reactive compositions with inorganic fillers.

3D objects that can be recycled into previously printed 3D material filler may be made of a thermosetting polymer using single component compositions or co-reactive compositions. A thermoset polymer is a polymer that is cured by heat, radiation, pressure, or mixing with a catalyst. Curing the polymer results in chemical reaction that creates cross-linking between polymer chains to produce a polymer network.

When the thermoset polymer is cured, it is transformed into a plastic or elastomer by crosslinking or chain extension through the formation of covalent bonds between individual chains of the polymer. There are multiple mechanisms of crosslinking such as copolymerization with unsaturated monomer diluents; homo-polymerization with anionic or cationic catalysts and heat; copolymerization through nucleophilic addition reactions with a hardener; combining isocyanate resins and prepolymers with low or high molecular weight polyols; polycondensation; and polymerization by exothermal ring-opening.

The recycled 3D objects can be made of different materials. Materials that may be used in a thermoset to create a 3D object that may be ground down into filler are polyester resin, polyurathanes, polyurea, vulcanized rubber, bakelite, duroplast, urea-formaldehyde, melamine resin, diallyl-phthalate, epoxy resin, epoxy novolacbenzoxazines, polyimides, cyanate esters, polycyanurates, mold runners, furan resins, silicone resins, thiol vinyl esters, or any other suitable material for 3D printing using a thermoset polymer.

The previously printed 3D material filler composition as disclosed herein may comprise a weight percentage of pigments from 0.1 wt. %, 0.15 wt. %, 0.2 wt. %, 0.3 wt. %, or 1 wt. % to 2 wt. %, 4 wt. %, 6 wt. %, 8 wt. %, or 10 wt. %, or within any range using any two of the foregoing as endpoints, such as 0.1 wt. % to 10 wt. %, 0.15 wt. % to 8 wt. %, 0.2 wt. % to 6 wt. %, 0.3 wt. % to 4 wt. %, or 1 wt. % to 2 wt. %, where weight percentage is based on the total weight of the co-reactive composition.

3D objects and/or scrap material may be made of single component compositions; co-reactive compositions, such as the chemistry described above; recycled paint or plastic; or any other suitable polymer that can be recycled into previously printed 3D material filler using the disclosed method.

### VII. Printing Using Recycled Previously Printed 3D Material Filler

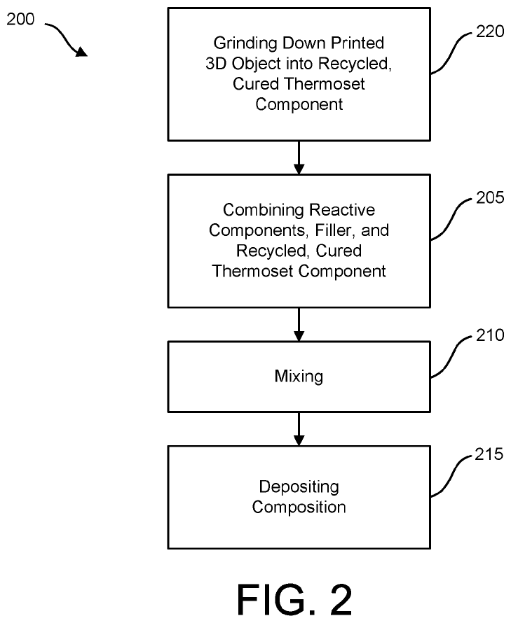

Referring to FIG. 2, a method 200 is shown for recycling a 3D printed object. Method 200 comprises a grinding step 220, a mixing step 220, and a depositing step 215. In grinding step 220, a previously printed 3D printed object is broken down into course pieces. The course pieces are ground finer by cryo-milling. Cryo-milling is a method of cooling a material and then reducing it to particles using mechanical milling. This process can be used to grind materials that would otherwise be hard to grind down at room temperatures. The cryo-milling process uses liquid nitrogen, dry ice, liquid carbon dioxide, or other means of achieving low temperatures to cool and embrittle a sample. The cooled sample is then subjected to mechanical milling where the course pieces are ground into fine particles. The extremely low temperatures suppress recovery and recrystallization of the composition of the sample, leading to finer grain structures and rapid grain refinement. In the presently disclosed method, the course pieces of the 3D printed object undergo cryo-milling to create fine previously printed 3D material filler.

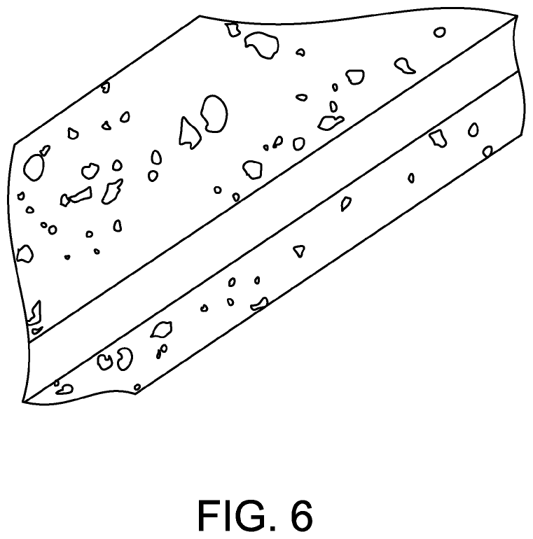

The particles of previously printed 3D material filler may have an average (Dn50) particle size less than 1000 microns, less than 800 microns, less than 600 microns, less than 400 microns, less than 200 microns, less than 150 microns, less than 100 microns, less than 100 microns, or less than 50 microns. The size of the particles can be determined by optical microscopy or any other suitable method of determining particle size. Morphology of the particles of previously printed 3D material fillers may be irregular and randomized. The morphology of the particles of previously printed 3D material filler may also be may be elongate or spherical. As seen in FIG. 6, there is no clear orientation within the matrix of the particles.

In combining step 205, a first reactive compound, a second reactive compound, and at least one non-recycled filler are combined, similar to step 105 of method 100 described above. Combining step 205 includes the previously printed 3D material filler created in step 220 so that the resulting composition includes a first co-reactive component, a second co-reactive component, a non-recycled filler described in the sections above, and the previously printed 3D material filler. Method 200 may comprise multiple combining steps, in which multiple components are combined, such as reactive components, non-recycled fillers, previously printed 3D material filler, additives, and pigments.

When pigment is added into the composition in step 205, the total wt. % of pigment added is reduced by the weight percentage of pigment in the previously printed material filler. The presence of pigment in the previously printed material filler reduces the amount of pigment needed in the new printed 3D object composition, thereby reducing cost, and material usage.

Mixing step 210 comprises mixing the first reactive compound, the second reactive compound, at least one non-recycled filler, and the previously printed 3D material filler to form a co-reactive composition. The mixing parameters such as time spent mixing, mixing speed, mixing device, temperature, and/or pressure may vary depending on operating parameters or desired product parameters such as the amount and type of compounds and fillers used, the volume of components in the mixture, desired properties of the co-reactive composition, desired properties of the printed object, and any combination of the foregoing. Mixing step 210 may be carried out in the same reservoir as the combining step 205. The mixing step 110 may be carried out in a static mixer. Mixing step 210 may comprise mixing devices such as baffles, paddles, impellors, agitators, and any combination of the foregoing. The first reactive compound may begin to react with the second reactive compound at any point after the combining step 205, such as during and/or after mixing step 210.

Depositing step 215 comprises depositing the co-reactive composition formed from mixing step 210 onto a printing surface to form a printed object. The printing surface may be a printing bed or any other material. As the object is built up, the printing surface may be a surface of the co-reactive composition that has already been deposited. The co-reactive composition may be extruded through a die from the mixer or mixing reservoir onto the printing surface. As the co-reactive composition reacts and cures, the composition may begin to solidify into a solid, 3D object. The speed of the reaction/curing may be altered through selection of the reactive compounds and filler(s) used, as well as through the conditions at which mixing step 210 and/or depositing step 215 occur. The mixing step 210 and depositing step 215 may occur at ambient conditions. As the co-reactive composition is deposited onto other layers or surfaces of already deposited co-reactive composition, the newly deposited composition may react/cure with the already deposited composition in order to form covalent bonds between the deposited layers. The newly deposited composition may also be deposited onto a composition that is entirely or mostly cured.

The depositing step 215 may be carried out through a 3D printing device. The co-reactive composition may be extruded through a printing head coupled to a movable printing arm onto a printing bed. The printing bed itself may be movable relative to the printing head and/or arm. Movement of the printing head relative to the printing bed, either through movement of the head/arm, the bed, or combinations thereof, allows for the deposition of material into a three-dimensional shape.

Different co-reactive compositions, reactive compounds, and/or fillers may be added or combined with other co-reactive compositions, reactive compounds, and/or fillers at any point during method 200. A first co-reactive composition may be deposited onto a printing bed, and a second co-reactive composition may be deposited onto the first co-reactive composition. Additionally, a first co-reactive composition may be made through a mixing step, and another filler may be added after the co-reactive composition was formed.

The amount of a co-reactive component may be dynamically changed during printing such that different parts can be fabricated using different print speeds. Certain portions of an object may have detail that is best fabricated using slower print speeds, while other portions of the object may be fabricated at higher print speeds. During the three-dimensional printing operation, the amount of a co-reactive component may be changed such that the gel time of the co-reactive composition is slower at slower print speeds, and faster at faster print speeds.

The co-reactive compositions with recycled 3D printed object particles and the printed objects formed from such a composition as disclosed herein may comprise at least one non-recycled filler. A co-reactive compositions with recycled 3D printed object particles and/or the printed objected formed from such a composition may comprise a weight percent of non-recycled filler from 1 wt. %, 2 wt. %, 3 wt. %, 4 wt. %, or 5 wt. % to 6 wt. %, 7 wt. %, 8 wt. %, 9 wt. %, or 10 wt. %, such as 1 wt. % to 10 wt. %, 2 wt. % to 9 wt. %, 3 wt. % to 8 wt. %, 4 wt. % to 7 wt. % or 5 wt. % to 6 wt. %, or within any range using any two of the foregoing as endpoints, where wt. % is based on the total weight of the total weight of the co-reactive composition and/or the printed product.

The co-reactive compositions with recycled 3D printed object particles and the printed objects formed from such a composition as disclosed herein may comprise particles of a previously printed 3D article filler material. A co-reactive compositions with recycled 3D printed object particles and/or the printed objected formed from such a composition may comprise a weight percentage of previously printed 3D material filler from 2 wt. %, 3 wt. %, 4 wt. %, 5 wt. %, 6 wt. %, 7 wt. %, or 8 wt. % to 9 wt. %, 10 wt. %, 11 wt. %, 12 wt. %, 13 wt. %, 14 wt. %, or 15 wt. %, or any range including any two of these values as endpoints, such as 2 wt. % to 15 wt. %, 3 wt. % to 14 wt. %, 4 wt. % to 13 wt. %, 5 wt. % to 12 wt. %, 6 wt. % to 11 wt. %, 7 wt. % to 10 wt. %, or 8 wt. % to 9 wt. %, wherein the weight percent is based on the total weight of the co-reactive composition and/or the printed product.

### VIII. Properties of Printed Objects with Previously Printed 3D Material Filler

The 3D printed objects made from the co-reactive component, non-recycled filler, and previously printed 3D material filler exhibit superior rheological characteristics and/or buildability when compared to standard co-reactive compositions with silica fillers and co-reactive compositions with high levels of silica fillers. As supported by at least rheology data shown in Example 4, compositions that contain the previously printed 3D material filler instead of a standard amount of non-recycled filler show less deformation from the weight of stacked layers, similar performance in tensile testing, and did not cause pumping issues as with the high non-recycled filler composition.

### A. Vertical Buildability

In particular, when beads of each material were printed on top of one another and the heights of the printed stacks were graphed against the number of layers of beads, the previously printed 3D material filler composition had the best fit line, indicating that there was less deformation during stacking. This is relevant in 3D printing in that, while building larger and taller parts with multiple layers of material stacked on top of one another, it is advantageous that the material resists deformation under its own weight.

Buildability of a material, in particularly in the context of 3D printing, may be described in many ways. Generally, a material is more buildable when the deposited material has consistent shape and size (e.g., under the same printing conditions such as volumetric extrusion rate and relative movement speed of the extruder v. substrate) throughout a print to allow controlled printing. When the deposited material deforms under its own weight, the breadth of objects that can be printed is limited by the number of layers the deposited material can withstand without the deformation. With low buildability, building taller or multilayered objects can result in sagging, collapse, or flawed printing.

The present disclosure measures buildability graphically by plotting the height of a stack of beads made of a composition against the number of layers in the stack and fitting a line to the data points. The better buildability a composition has, the less deformation each layer will cause, and the smaller the absolute value of the second order component of the equation of the best fit line will be. For example, when the print path is designed for a 1 mm nozzle to be printed at a fly height (i.e., distance between the nozzle tip to the substrate or the previous layer) of 1 mm such that each bead has an expected height of 1 mm, each layer would be expected to add no less than 1 mm of height to the stack of beads being printed. So a stack of two beads will be 2 mm in height and a stack of five beads will be 5 mm in height. When adding a best fit line to the plotted data points, a material would be considered more buildable when the best fit line of the data points has a second order component that is closer to zero.

Once the equation for the line of the plotted data points is determined, the second order component can indicate how straight the line is. The closer the absolute value of the second order component is to zero, the straighter the line. The straighter the line is, the better the buildability of the material. The absolute value of the second order component of an acceptable composition for 3D printing may from 0.05, 0.04, 0.03, 0.025, 0.02, or 0.015,0.01, 0.009, 0.007, 0.005, 0.002, or 0.001, or within any range using any two of the foregoing as endpoints, such as 0.05 to 0.001, 0.04 to 0.002, 0.03 to 0.005, 0.025 to 0.007, 0.02 to 0.009, or 0.015 to 0.01.

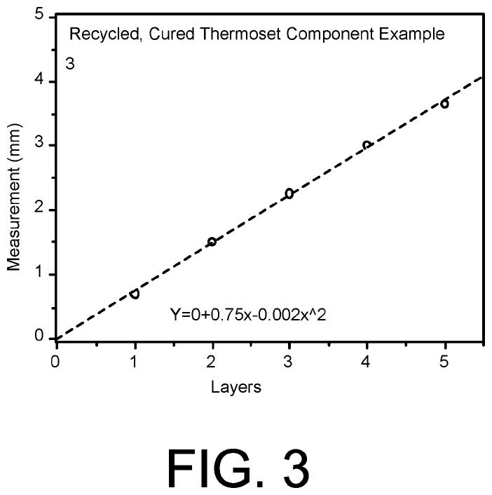

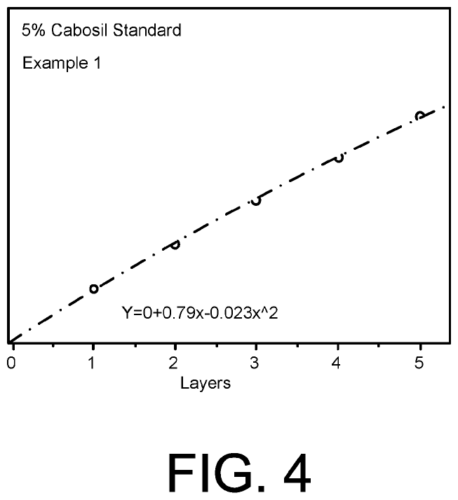

Referring to FIG. 3, one to five beads made of a composition that included the previously printed 3D material filler were stacked, measured and had the height of the stack plotted against the number of beads in the stack. The data points have a best fit line with the equation y=0+0.75x−0.002x². The absolute value of the second order component of quadratic is 0.002. The ratio of mm to layers is 0.75, meaning the composition of FIG. 3 has good buildability. Looking at FIG. 4, one to five beads made of a composition that included the standard non-recycled filler, CAB-O-SIL, were stacked, measured and had the height of the stack plotted against the number of beads in the stack. The data points have a best fit line with the equation y=0+0.79x−0.023x². The absolute value of the second order component of quadratic is 0.023. The ratio of mm to layers for the composition that includes recycled filler is 0.79, meaning the composition of FIG. 4 has good buildability.

### B. Shear Viscosity

The viscosity of a composition meant for extrusion to make a 3D object is an influential factor that affects the success of printing a 3D object. A composition with a high viscosity can clog up the nozzle used for printing or extrude at a slower rate than needed to make an accurate object. A composition with too low viscosity may flow and spread out too quickly to be used to print intricate 3D objects. As seen in example 4, co-reactive compositions containing high amount of non-recycled filler have a high viscosity and may have low flow rates that negatively affect the printing of a 3D object. However, the co-reactive composition with previously printed 3D material filler achieved a shear viscosity similar to the standard composition for 3D printing while still having double the filler than the standard composition. Acceptable shear viscosity for a composition used in 3D printing is from 1.0×10³ mPa*s, 1×10⁴ mPa*s, or 1×10⁵ mPa*s to 1×10⁶ mPa*s, 1×10⁷ mPa*s, or 1.0×10⁸ mpa*s, or within any range using any two of the foregoing as endpoints, such as 1.0×10³ mPa*s to 1.0×10⁸ mPa*s, 1×10⁴ mPa*s to 1×10⁷ mPa*s, or 1×10⁵ mPa*s to 1×10⁶ mPa*s. A suitable composition has a shear viscosity from 7.23*10⁶ to 5.68*10⁷ mPa*s at a shear rate of 0.01 s⁻¹ through to the use of an Anton-Paar Rheometer at 25° C.

### C. Young's Modulus

Using previously printed 3D material as filler can achieve a printed 3D object with similar tensile stiffness to a 3D printed object with standard filler. Tensile stiffness of a solid material is measured by the mechanical property Young's modulus. Young's modulus quantifies the relationship between tensile stress and axial strain in the linear elastic region of a material. 3D printed objects have Young's modulus values from 1 MPa, 500 MPa, 1000 MPa, or 1500 MPa to 2500 MPa, 3000 MPa, 3500 MPa or 4000 MPa, or within any range using any two of the foregoing as endpoints, such as 1 MPa to 4000 MPa, 500 MPa to 3500 MPa, 1000 MPa to 3000 MPa, or 1500 MPa to 2500 MPa. A suitable composition has a Young's modulus of from 1065-1295 MPa as evaluated following the ASTM D638.

### D. Maximum Tensile Strength

The maximum stress that a material can withstand while being stretched or pulled before breaking or permanent deformation is the maximum tensile strength or tensile strength. When previously printed 3D printed material is used as filler in a co-reactive composition for 3D printing, the new 3D printed object may experience similar tensile strength to that of a 3D printed object with standard filler used. 3D printed objects may have a tensile strength from 1 MPa, 20 MPa, or 30 MPa to 50 MPa, 60 MPa, or 70 MPa, or within any range using any two of the foregoing as endpoints, such as 1 MPa to 70 MPa, 20 MPa to 60 MPa, or 30 MPa to 50 MPa. A suitable composition has a maximum tensile stress of from 38 to 48 MPa as evaluated following the ASTM D638.

### E. Elongation at Break Percentage

Co-reactive material used for 3D printing may be measured for the elongation at break property. Elongation at break is the percent increase in length that a material experiences before breaking. This percentage may be measured by the test method ASTM D638. The measurement indicates the ability of a material to undergo deformation before breaking. Materials with a higher elongation at break percentage have higher ductility. Adding in previously printed 3D material as filler to a co-reactive composition for 3D printing results in a higher elongation at break percentage than the standard co-reactive composition with high filler. 3D printed materials from a co-reactive composition experience an elongation at break percentage from 1%, 200%, 400%, 600%, or 800% to 1200%, 1400%, 1600%, 1800%, or 2000%, or within any range using any two of the foregoing as endpoints, such as 1% to 2000%, 200% to 1800%, 400% to 1600%, 600% to 1400%, or 800% to 1200%. A suitable composition has an elongation at break of from 9 to 17% as evaluated following the ASTM D638.

### F. Shore D Hardness

Shore D Hardness is a test for measuring the depth of penetration of a specific indenter. This test is commonly used to measure the hardness of polymers, elastomers, and rubbers. The higher the number, the greater the resistance to indentation and the harder the material. When previously printed 3D material filler was added to the standard co-reactive composition to print 3D materials, the resulting object had a similar hardness to standard co-reactive compositions with non-recycled material. Compositions used to make 3D printed objects may have a Shore D Hardness from 1, 20, 30, 40, 50, or 60, 70, 80, 90, or 99, or within any range using any two of the foregoing as endpoints, such as 1 to 99, 20 to 90, 30 to 80, 40 to 70, or 50 to 60. A suitable composition has a Shore D hardness of from 78 to 83 MPa as evaluated following the ASTM D2240.

### EXAMPLES

Aspects of the present disclosure are further illustrated by reference to the following examples. It will be apparent to those skilled in the art that many modifications, both to materials, and methods, may be practiced without departing from the scope of the disclosure.

### Example 1—Polyurea Composition

In this example, a 3D printable, 2K polyurea composition with a 5 weight % loading of Cabosil TS-720² was printed and evaluated for tensile properties, buildability, and viscosity. The amine-side composition was prepared from the components in Table 3.

TABLE 3
A - Amine-side composition

| | Part by |
|---|---|
| Component | weight (g) |
| ¹Desmophen NH-1420 | 95.00 |
| ²Cabosil TS-720 | 5.00 |

¹Desmophen NH-1420, aspartic ester di-amine, CAS# 136210-30-5, commercially available from Covestro LLC
²Cabosil TS-720, fumed silica, commercially available through Cabot Corporation

From Table 3, Desmophen NH-1420¹ and Cabosil TS-720² were weighed into a Max 300 L DAC cup from Flacktek and mixed via a typical Speedmixer procedure. This mixture was then transferred to an Optimum cartridge via Flacktek SpeedDisc.

The isocyanate-side composition was prepared from the components in Table 4.

TABLE 4
B - Isocyanate-side composition

| | Part by weight |
|---|---|
| Component | (g) |
| ³Desmodur N3900 | 90.00 |
| ²Cabosil TS-720 | 5.00 |

³Desmodur N3900, aliphatic polyisocyanate, CAS# 28182-81-2, commercially available through Covestro LLC

From Table 4, Desmodur N3900³ and Cabosil TS-720² were weighed into a Max 300 L DAC cup from Flacktek and mixed via a typical Speedmixer procedure. This mixture was then transferred to an Optimum cartridge via Flacktek SpeedDisc.

The cartridges with the compositions were then configured for 3D printing via ambient reactive extrusion utilizing Viscotec 2k extruders mounted to a gantry such as the Lulzbot Taz 6. Dogbones conforming to ASTM D638 and buildability squares were then printed by extruding at a mix ratio of 1.6:1 A:B. Tensile properties were evaluated following the ASTM D638. Buildability metrics were measured by comparing the resulting height of the buildability square to the intended height. Viscosity values were recorded through the use of an Anton-Paar Rheometer at 25° c. A summary of the data collected using the methods described above are listed in Table 5.

TABLE 5
Quantitative metrics for the standard rigid polyurea composition

| Metric | Value |
|---|---|
| Young's Modulus (MPa) | 1295 |
| Maximum Tensile Stress (MPa) | 48 |
| Elongation at Break (%) | 17 |
| Vertical Buildability (% Error from model) | 5.9 |
| Low Shear Viscosity @ 0.01 1/s (mPa*s) | 7.23 × 10⁶ |

### Example 2—Polyurea Composition with Additional Silica Filler

A 3D printable, 2K polyurea composition with a 10 weight % loading of Cabosil TS-720² was printed and evaluated for tensile properties, buildability, and viscosity. The amine-side composition was prepared from the components in Table 6.

TABLE 6
A - Amine-side composition

| | Part by weight |
|---|---|
| Component | (g) |
| ¹Desmophen NH-1420 | 90.00 |
| ²Cabosil TS-720 | 10.00 |

From Table 6, Desmophen NH-1420¹ and Cabosil TS-720² were weighed into a Max 300 L DAC cup from Flacktek and mixed via a typical Speedmixer procedure. This mixture was then transferred to an Optimum cartridge via Flacktek SpeedDisc. The isocyanate-side composition was prepared from the components in Table 7.

TABLE 7
B - Isocyanate-side composition

| | Part by weight |
|---|---|
| Component | (g) |
| ³Desmodur N3900 | 90.00 |
| ²Cabosil TS-720 | 10.00 |

From Table 7, Desmodur N3900³ and Cabosil TS-720² were weighed into a Max 300 L DAC cup from Flacktek and mixed via a typical Speedmixer procedure. This mixture was then transferred to an Optimum cartridge via Flacktek SpeedDisc.

The cartridges with the compositions were then configured for 3D printing via ambient reactive extrusion utilizing Viscotec 2k extruders mounted to a gantry such as the Lulzbot Taz 6. Dogbones conforming to ASTM D638 and buildability squares were then printed by extruding at a mix ratio of 1.6:1 A:B. Tensile properties were evaluated following the ASTM D638. Buildability metrics were measured by comparing the resulting height of the buildability square to the intended height. Viscosity values were recorded through the use of an Anton-Paar Rheometer at 25° C. A summary of the data collected using the methods described above are listed in Table 8.

TABLE 8
Quantitative metrics for the rigid polyurea
composition with additional cabosil filler

| Metric | Value |
|---|---|
| Young's Modulus (MPa) | 1129 |
| Maximum Tensile Stress (MPa) | 42 |
| Elongation at Break (%) | 9 |
| Vertical Buildability (% Error from model) | 4.5 |
| Low Shcar Viscosity @ 0.01 1/s (mPa*s) | 5.68 × 10⁷ |

### Example 3—Polyurea Composition with Around ARE Filler

A 3D printable, 2K polyurea composition with a 5 weight % loading of Cabosil TS-720² and 5 weight % of Ground ARE Filler⁴ was printed and evaluated for tensile properties, buildability, and viscosity.

The amine-side composition was prepared from the components in Table 9.

TABLE 9
A - Amine-side composition

| | Part by |
|---|---|
| Component | weight (g) |
| ¹Desmophen NH-1420 | 90.00 |
| ²Cabosil TS-720 | 5.00 |
| ⁴Ground ARE Filler | 5.00 |

⁴Ground ARE Filler, ground polyurea material containing 5 weight % of Cabosil TS-720 and 1 weight % carbon black pigment with a particle size of 50-200 um, produced by PPG Industries

From Table 9, Desmophen NH-1420¹ and Cabosil TS-720² were weighed into a Max 300 L DAC cup from Flacktek and mixed via a typical Speedmixer procedure. The ground ARE filler⁴ was then added to the DAC cup and the mixing procedure was repeated. This mixture was then transferred to an Optimum cartridge via Flacktek SpeedDisc. The isocyanate-side composition was prepared from the components in Table 10.

TABLE 10
B - Isocyanate-side composition

| | Part by weight |
|---|---|
| Component | (g) |
| ³Desmodur N3900 | 90.00 |
| ²Cabosil TS-720 | 5.00 |
| ⁴Ground ARE Filler | 5.00 |

From Table 10, Desmodur N3900³ and Cabosil TS-720² were weighed into a Max 300 L DAC cup from Flacktek and mixed via a typical Speedmixer procedure. The ground ARE filler was then added to the DAC cup and the mixing procedure was repeated. This mixture was then transferred to an Optimum cartridge via Flacktek SpeedDisc.

The cartridges with the compositions were then configured for 3D printing via ambient reactive extrusion utilizing Viscotec 2k extruders mounted to a gantry such as the Lulzbot Taz 6. Dogbones conforming to ASTM D638 and buildability squares were then printed by extruding at a mix ratio of 1.6:1 A:B. Tensile properties were evaluated following the ASTM D638. Buildability metrics were measured by comparing the resulting height of the buildability square to the intended height. Viscosity values were recorded through the use of an Anton-Paar Rheometer at 25° c. A summary of the data collected using the methods described above are listed in Table 11.

TABLE 11
Quantitative metrics for the standard rigid polyurea composition

| Metric | Value |
|---|---|
| Young's Modulus (MPa) | 1065 |
| Maximum Tensile Stress (MPa) | 38 |
| Elongation at Break (%) | 11 |
| Vertical Buildability (% Error from model) | 4 |
| Low Shear Viscosity @ 0.01 1/s (mPa*s) | 7.74 × 10⁶ |

Example 4—Polyurea composition with increasing loadings of ground ARE filler Similar to Example 3, a 3D printable, 2K polyurea composition with a 5 weight % loading of Cabosil TS-720² and a 5 weight % of Ground ARE Filler⁴ is 3D printed. Multiple formulations following the same procedure as outlined in Example 3 is then made with progressive amounts of Ground ARE Filler⁴ added. The formulations with additional Ground ARE Filler⁴ is still 3D printable and maintain acceptable material properties. However, once the loading reaches 35 weight % of Ground ARE Filler⁴, the viscosity of the resulting formulation is too high to print successfully.

### Example 5—Key Metric Comparisons for Ground ARE Filler

The addition of ground ARE filler as described in example 3 showed key benefits in rheology and buildability while maintaining good results for tensile and hardness properties when compared to the standard cabosil loading, example 1, and equivalent total filler loading comparison, example 2.

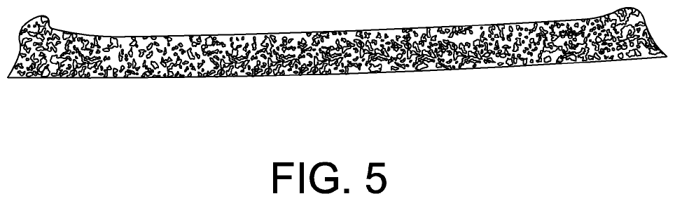

The ground ARE composition, example 3, showed enhanced buildability benefits over the standard system, example 1. To represent this property, beads of each material were printed on top of each other and a height measurement was taken at each new layer. The overall height of the stack was then plotted against the number of layers in the stack and a quadratic was fit to the resulting line. The more buildable composition was determined to be the composition with the smaller absolute value of the second order component. This second order component represented the loss in height due to the weight of additional beads being placed on top of previously printed beads. FIG. 3 is a plot of the vertical height of each stack of deposited composition containing ground ARE composition as filler as a function of stack layer. FIG. 5 shows an example of a four layer stack of the deposited composition containing ground ARE composition as filler. FIG. 4 is a plot of the vertical height of each stack of deposited composition containing standard composition of co-reactive composition and filler as a function of stack layer.

Table 12 shows the second order components of the quadratic fits for the standard composition, example 1, and the composition with added ground ARE, example 3.

TABLE 12
Second order components of the quadratic
fits for the buildability testing

| Example | Second Order Component of Quadratic |
|---|---|
| Standard- Example 1 | −0.023 |
| Ground ARE- Example 3 | −0.002 |

The ground ARE composition, example 3, showed negligible influence on the rheology of the system as compared to the standard system, example 1. An example with a higher 10% loading of fumed silica, example 2, was also measured as a direct comparison as it had the same 10% filler loading as example 3. The addition of the ground ARE without impacting rheology is beneficial. This system allows for additional filler to be added without increasing the low shear viscosity, a key metric in pumping of materials. Table 13 shows the low shear viscosities of the samples and how ground ARE achieved a higher filler loading without raising the low shear viscosity significantly.

TABLE 13
Low shear viscosities of the example compositions

| | Low Shear Viscosity (mPa*s) |
|---|---|
| Example | (Shear Rate = 0.01 1/s) |
| Standard- Example 1 | 7.2 × 10⁶ |
| Standard with High Filler - Example 2 | 5.7 × 10⁷ |
| High Filler Ground ARE- Example 3 | 7.7 × 10⁶ |

The addition of the ground ARE composition, example 3, showed similar tensile and hardness properties to the equivalent 10% filler composition, example 2. Both examples 2 and 3 showed lowered Young's Modulus, Maximum Tensile Stress, Tensile Strain at break, and Shore D hardness when compared to the low filler composition, example 1. This was due to an increased overall loading in filler. The composition with ground ARE, example 3, showed similar results to the highly loaded cabosil composition, example 2. Table 14 below shows the tensile and hardness values for each of these example compositions.

TABLE 14
Tensile Properties and hardness of the example compositions

| | | Maximum | | |
|---|---|---|---|---|
| | Young's | Tensile | Tensile | |
| | Modulus | Stress | Strain at | Hardness |
| Example | (MPa) | (MPa) | Break (%) | (Shore D) |
| Standard- | 1295 | 48 | 17 | 83 |
| Example 1 | | | | |
| Standard with | 1129 | 42 | 10 | 78 |
| High Filler - | | | | |
| Example 2 | | | | |
| High Filler | 1065 | 39 | 11 | 80 |
| Ground ARE- | | | | |
| Example 3 | | | | |

### Example 6—Buildability Example

The buildability testing explained in example 4 was designed to quantify the amount of deformation in a stack of printed beads. This test was performed by printing beads of material in incrementally taller stacks. Bead stacks from 1 and 5 beads tall were then measured for their heights and plotted. The y-axis was set to be the total stack height and the x-axis was set to be the number of beads in each measured stack. A quadratic equation was then fit to each plot with a set of constraints. The first constraint was that the y-intercept was constrained to 0. This was because a bead stack with no beads in it naturally has a height of zero. Secondly, the first order component of the fit was fit to the stacks with 1 and two beads, respectively. This was defined because the first beads height should be closest to the natural height of a bead without deformation due to additional weight being placed upon it. After these constraints were placed the best fitting second order component for the remaining beads measured was found without constraints. This second order component described the rate at which the bead stack was decreasing in height due to the weight of additional beads being placed upon it. This second order component was negative, but a greater absolute value of the second order component represented a bead stack that lost more height at each consecutive addition of a bead. This loss of height was correlated to the buildability of an ambient reactive extrusion composition.

Whereas particular examples of this disclosure have been described above for purposes of illustration, it will be evident to those skilled in the art that numerous variations of the details of the present disclosure may be made without departing from what is defined in the appended claims.

1. A composition for reactive additive manufacturing, comprising:
a first reactive component;
a second reactive component, the first and second reactive components reactive with each other;
particles comprising a cured thermoset component, the particles present in an amount greater than 2 wt. % based on a total weight of the composition; and
a filler present in an amount of from 1 to 10 wt. % based on the total weight of the composition.

2. The composition of claim 1, wherein the composition has a shear viscosity from 1×10³ mPa*s to 1×10⁸ mPa*s at a shear rate of 0.01 s⁻¹ through to the use of an Anton-Paar Rheometer at 25° C.

3. The composition of claim 1, wherein the cured thermoset component particles have an average (Dn50) particle size less than 1 mm, as determined by optical microscopy.

4. The composition of claim 1, wherein the cured thermoset component particles have an elongate, spherical, or irregular, randomized morphology.

5. The composition of claim 1, wherein the cured thermoset component particles further comprise a pigment.

6. The composition of claim 1, wherein the cured thermoset component particles comprise one or more pigments present in a total amount from 0.0002 to 0.05 wt. % based on the original pigment added in the composition of the cured thermoset component particles divided by the total weight of the cured thermoset component particles added to the formulation.

7. The composition of claim 1, wherein the first reactive component is at least one compound selected from the group of an isocyanate, an acrylate, and an epoxy, and the second reactive component is at least one compound selected from the group of an amine, a thiol, and a polyol.

8. The composition of claim 1 which, when deposited to form a stack of beads having a single-bead-width using a 1 mm nozzle size and a 1 mm fly height, shows a best fit line according to y=ax²+bx+c, and fits to a quadratic equation for stack height with an absolute value of a second order component less than 0.02.

9. The composition of claim 1, wherein the cured thermo set component comprises of the two previously reactive components.

10. The composition of claim 1, wherein the wt. % of particles comprising the reaction product of the cured thermo set component are present in the amount of greater than 2 wt. % to 15 wt. % based on a total weight of the composition.

11. A method of forming an object with a reactive additive manufacturing composition, comprising:
combining a first reactive component, a second reactive component, and particles comprising a reaction product of a cured thermo-set component, the cured thermoset component particles present in an amount of at least 2 wt. % based on a total weight of the composition;
mixing the first reactive component, second reactive component, and the cured thermoset component particles; and
sequentially depositing the composition in a plurality of layers to form a three-dimensional object.

12. The method of claim 11, wherein the three-dimensional object has at least one of the following properties:
a Young's modulus of from 1 to 4000 MPa as evaluated following the ASTM D638;
a maximum tensile stress of from 1 to 70 MPa as evaluated following the ASTM D638;
an elongation at break of from 1 to 2000% as evaluated following the ASTM D638; and
a Shore D hardness of from 1 to 99 MPa as evaluated following the ASTM D2240.

13. The method of claim 11, wherein the cured thermoset component particles have an average particle size less than 1 mm, as determined by as determined by optical microscopy.

14. The method of claim 11, wherein the reaction product particles have an elongate, spherical, or irregular, randomized morphology.

15. The method of claim 11, wherein the cured thermoset component particles further comprise a pigment.

16. The method of claim 11, wherein the cured thermoset component particles comprise one or more pigments present in a total amount of from 0.0002 to 0.05 wt. % based on the original pigment added in the composition of the cured thermoset component particles divided by the total weight of the cured thermoset component particles added to the formulation.

17. The method of claim 11, wherein the first reactive component comprises a compound selected from the group of an isocyanate, an acrylate, and an epoxy, and the second reactive component comprises a compound selected from the group of an amine, a thiol, and a polyol.

18. The method of claim 11, wherein when the sequential depositing of the method is in the form of a single-bead-width using a 1 mm nozzle size and a 1 mm fly height and a number of layers of beads is plotted against the height of the bead stack, a best fit line of the plotted points has an absolute value of a second order component of a quadratic fit less than 0.02.

19. The method of claim 11, wherein the combining step further comprises combining a filler in an amount of 1 to 10 wt. % based on the total weight of the composition.

20. (canceled)
